(19) United States
(12) Patent Application Publication
(10) Pub. No.: US 2021/0291041 A1
(43) Pub. Date: Sep. 23, 2021

(54) VIDEO GAME WITH HAPTIC STIMULATION CONTROL

(71) Applicant: MB Technologies LLC, SANFORD, NC (US)

(72) Inventor: John Pounders, Nashville, TN (US)

(21) Appl. No.: 17/207,544

(22) Filed: Mar. 19, 2021

Related U.S. Application Data
(60) Provisional application No. 62/992,802, filed on Mar. 20, 2020.

(51) Int. Cl. A63F 13/285; A63F 13/52

(52) U.S. Cl. CPC A63F 13/285; A63F 2300/1037; A63F 13/52

(57) ABSTRACT

A haptic stimulation device may be controlled based on received user input for interacting with a video game application running on a computing device. Based on a determination that the interacting has triggered a haptic feedback condition of the video game application, haptic feedback commands including a haptic stimulation effect may be generated based on the triggered haptic feedback condition. The haptic feedback commands may be transmitted to the haptic stimulation device for execution of the haptic stimulation effect. The haptic stimulation effect may include a vibration, a suction, a thrust and/or a twirl. The haptic feedback commands may also include haptic stimulation parameters, such as a haptic stimulation pattern, a haptic stimulation intensity or a haptic stimulation duration associated with the execution of the haptic stimulation effect. The haptic stimulation parameters may be limited based on an override condition, such as a capability of the haptic stimulation device.

### CROSS-REFERENCE TO RELATED APPLICATION

This application claims the benefit of and priority to U.S. provisional application Ser. No. 62/992,802, filed on Mar. 20, 2020, the content of which is hereby incorporated by reference in its entirety.

### TECHNICAL FIELD

The present disclosure generally relates to methods and systems for controlling haptic stimulation based on video game activity, and more particularly to controlling a haptic stimulation device based on events in a video game.

### BACKGROUND

Haptic stimulation refers to the stimulation of the sense of touch through technology by applying forces (e.g., vibrations or suctions) to a portion of a user's body. Haptic feedback refers to haptic stimulation provided in response to some user action. A basic haptic feedback may be purely mechanical, such as providing a clicking sensation when a button is pressed. However, more advanced haptic feedback may be provided by a device using electro-mechanical means, such as one or more motors. For example, a vibratory sensation may be imparted by a haptic stimulation device based on an electric motor being turned on and off. Haptic feedback has been used in video gaming applications, for example, an actuator of a video game console controller may provide haptic stimulation in response to a command signal from the video game console. Similarly, handheld mobile devices (e.g., cell phones, tablet computers) may now include hardware (e.g., internal electric motor) that permits applications to provide haptic feedback effects to user of the handheld mobile devices.

Haptic stimulation devices for personal stimulation (e.g., sex toys) may be operated from a distance, this may be referred to as “teledildonics” (also as “cyberdildonics”). Teledildonics includes technology for remote sexual stimulation (e.g., remote masturbation), wherein the particulars of a tactile stimulation effect (different intensities, different durations, a variety of pulses, etc.) are communicated over a data link to the haptic stimulation device. Although sexual stimulation devices have become more accepted in society, they may still function independently from the other elements of a modern home entertainment environment and therefore may not benefit from the interconnectivity of the modern home entertainment environment.

### BRIEF DESCRIPTION OF THE DRAWINGS

FIG. 1 is a block diagram of a system for video game control of a haptic stimulation device, according to embodiments of the present disclosure.

FIGS. 2A-2B are use cases of a system for video game control of a haptic stimulation device, according to embodiments of the present disclosure.

FIG. 3 is a flow diagram of a method for video game control of a haptic stimulation device, according to embodiments of the present disclosure.

FIG. 4 is a flow diagram of a method for video game control of a haptic stimulation device, according to embodiments of the present disclosure.

FIG. 5 is a flow diagram of a method for video game control of a haptic stimulation device, according to embodiments of the present disclosure.

FIG. 6 is a block diagram of a computer system operating in accordance with one or more embodiments of the present disclosure.

### DETAILED DESCRIPTION

As noted above, some video game controllers now have internal motors configured to cause the video game controller to physically vibrate in order to provide haptic feedback to give a player of the video game a greater sense of immersion in the video game. For example, the video game may be programmed in such a way that when a collision occurs between two objects displayed by the video game, the internal motors of the controller are turned on and cause a minor shaking of the controller. These haptically-enabled controllers have created a desire for more varied forms of haptic feedback systems that may provide new sensations (e.g., sexual stimulation effects) to enhance the video game experience.

### System

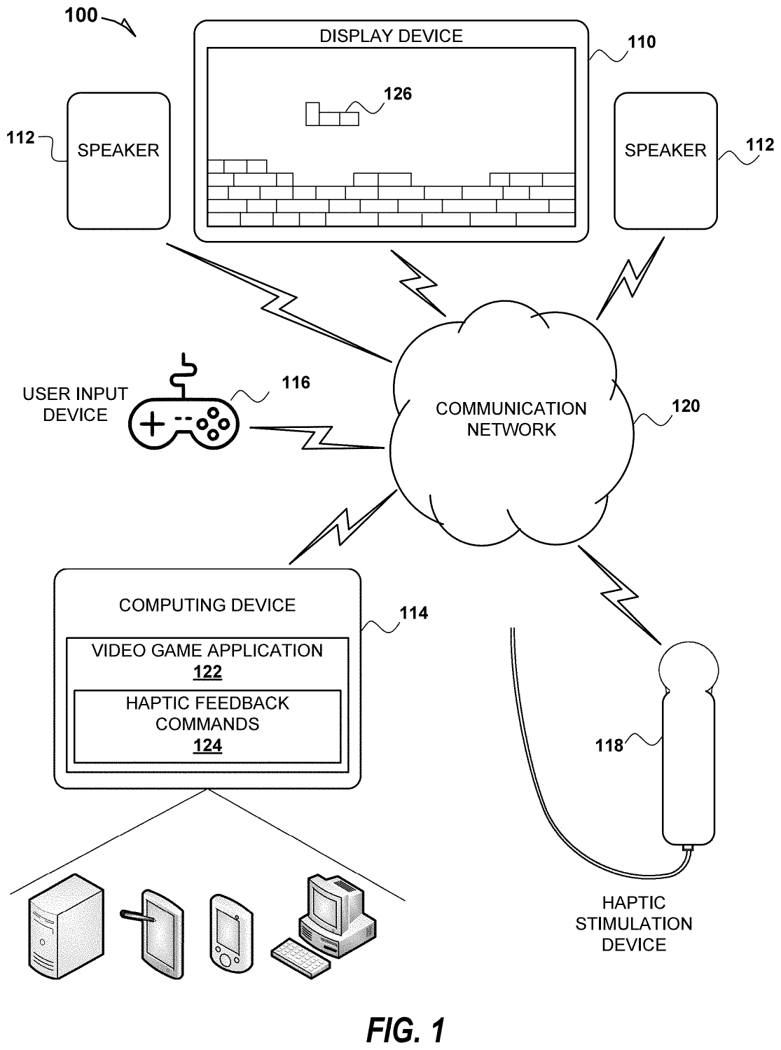

FIG. 1 is a block diagram of an example system 100 for control of a haptic stimulation device 118 by a video game application 122, according to embodiments of the present disclosure.

In some embodiments of the present disclosure, the system 100 is a home entertainment system including a display 110 (e.g., a television or a computer monitor), a plurality of speakers 112, a computing device 114 (e.g. a computer or a gaming console such as a Sony PlayStation™ or a Microsoft XBOX™) with at least one user input device 116 (e.g., gaming controllers), a haptic stimulation device 118 (e.g., a vibrator or a wearable device) and a communication network 120 (e.g., wireless home network, cell network, internet, infrared, Bluetooth, etc.). Although the elements of system 100 are shown to be in communication via communication wireless network 120, the elements of system 100 may alternatively communicate with each other via wired connections. In some embodiments, computing device 114 may comprise a desktop computing device, a handheld device (e.g., smart phone), a personal digital assistant (PDA), a tablet device, a laptop device, a server, or a handheld navigation system.

The computing device 114 shown in FIG. 1 may run a video game application 122 by receiving input signals (e.g., from user input device 116) and generating command signals for displaying the video game application 122 (e.g., via display 110) and for providing haptic feedback commands 124 (e.g., to haptic stimulation device 118 for execution of a haptic stimulation effect). The user input device 116 may comprise a touchscreen, a button, a switch, a slider, or a trackball or any combination thereof.

Haptic stimulation device 118 (e.g., a sexual stimulation device or sex toy) may be configured to provide one or more haptic stimulation effects. The system 100 may include a single or multiple haptic stimulation device(s) 118 and may include the same type or a combination of different types of haptic stimulation device(s) 118. In some embodiments, one or more haptic stimulation device(s) may be directly or indirectly in communication with computing device 114, such as via wired or wireless communication (e.g., via communication network 120). In some embodiments, haptic feedback commands may be generated by the computing device 114 based on an event occurring during play of video game application 122 (e.g., a player scores a point). The haptic feedback commands may then be transmitted to haptic stimulation device 118 so that it may then output a haptic stimulation effect (e.g., vibrations, thrusts, twirls, suctions or other such haptic stimulation effects) based on the haptic feedback commands. In some embodiments, the computing device 114 may also generate haptic stimulation parameters based on an event occurring during play of video game application 122. The haptic feedback commands 124 may then also include the haptic stimulation parameters (e.g., intensity, pattern, duration, etc.) to be implemented by the haptic stimulation device 118 in the execution of the specific haptic stimulation effect.

In other embodiments, different haptic feedback commands 124 may be sent to each of the one or more haptic stimulation device(s) 118. For example, computing device 114 may transmit first haptic feedback commands 124 to drive a first haptic stimulation device 118 of a first video game player who has just triggered a “lost” haptic feedback condition during play of video game application 122 (e.g., lost a point in a match) to output a lower-level of the haptic stimulation effect (e.g., lower intensity, more sporadic pattern or shorter duration) and transmit second haptic feedback commands 124 to drive a second haptic stimulation device 118 of a second player of video game application 122 who has just triggered a “won” haptic feedback condition (e.g., won the point in the match) to output a higher-level of the haptic stimulation effect.

As noted above, one or more haptic stimulation effects (e.g., vibrations, thrusts, twirls, suctions, etc.) may be produced by the haptic stimulation device 118. For example, the computing device 114 may command (e.g., via transmission of haptic feedback commands 124) the haptic stimulation device 118 to vibrate (or thrust or twirl, etc.) at a maximum level (e.g., may be configured by the user as explained below) for a specified time period (e.g., also configurable by the user) based on a “failure” event occurring during play of video game application 122 (e.g., a player's avatar in video game 122 crashes against a wall or falls off of a cliff). In another example, the computing device 114 may command the haptic stimulation device 118 to vibrate (or thrust or twirl, etc.) at a level that corresponds to a position of a video game element 126 on the display 110 during play of video game application 122 (e.g., a position of a puzzle piece in puzzle video game like Tetris by AcademySoft). In yet another example, the computing device 114 may command the haptic stimulation device 118 to vibrate (or thrust or twirl, etc.) at a level that corresponds to a speed and/or an acceleration of an element of video game application 122 on the display 110 (e.g., based on a speed and/or acceleration of a car shown on display 110 during a racing video game).

### Use Case

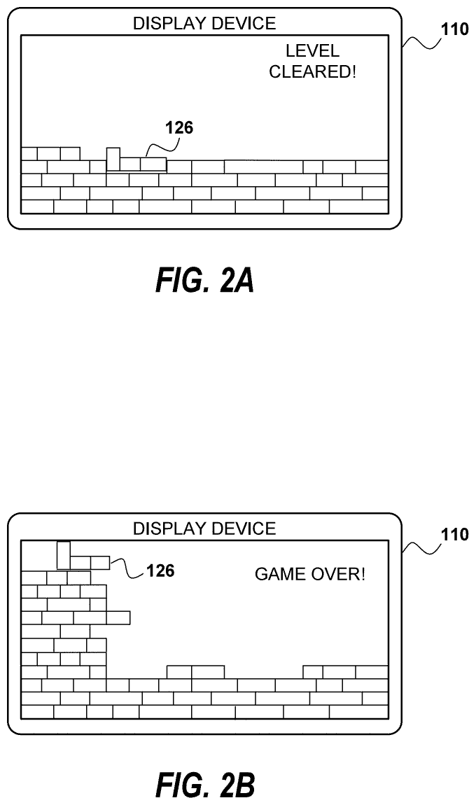

FIGS. 2A-2B are use cases of a system 100 for control of a haptic stimulation device 118 by a video game application 122, according to embodiments of the present disclosure.

As noted above, the computing device 114 may command (e.g., via transmission of haptic feedback commands 124) the haptic stimulation device 118 to execute a haptic stimulation effect (e.g., suction, thrust or twirl, etc.) according to haptic stimulation parameters (e.g., an intensity level or a duration) based on a haptic feedback condition of video game application 122 being triggered (e.g., a player's avatar in video game 122 crashes against a wall or falls off of a cliff).

For example, in FIG. 2A a player of video game application 122 may control the movement of video game element 126 (in the form of a puzzle piece) on display device 110 such that a “success” haptic feedback condition is triggered (e.g., “LEVEL CLEARED!”) by the position of the puzzle piece (e.g., fits into the puzzle). As noted above, the haptic stimulation parameters associated with the haptic feedback commands transmitted to the haptic stimulation device 118 based on the “success” haptic feedback condition being triggered may produce a higher intensity or longer duration haptic stimulation effect. Of course, the haptic stimulation parameters may be lowered or left untouched by the triggering of the very same haptic feedback condition of video game application 122. In fact, the effect of a “failure” or “success” may even be configured by a user of system 100.

In another example, FIG. 2B shows that the player of video game application 122 may control the movement video game element 126 (in the form of a puzzle piece) on display 110 such that a position of the puzzle piece on display 110 such that a “failure” haptic feedback condition of video game application 122 is triggered (e.g., “GAME OVER!”) by the position of the puzzle piece (e.g., placed puzzle piece 126 is placed too close to the top of display 110). As noted above, the haptic stimulation parameters associated with the haptic feedback commands transmitted to the haptic stimulation device 118 based on the “failure” haptic feedback condition being triggered may produce a lower intensity or shorter duration haptic stimulation effect. Of course, the haptic stimulation parameters may be lowered or left untouched by the triggering of the very same haptic feedback condition of video game application 122. In fact, the effect of a “failure” or “success” may even be configured by a user of system 100.

### Methods

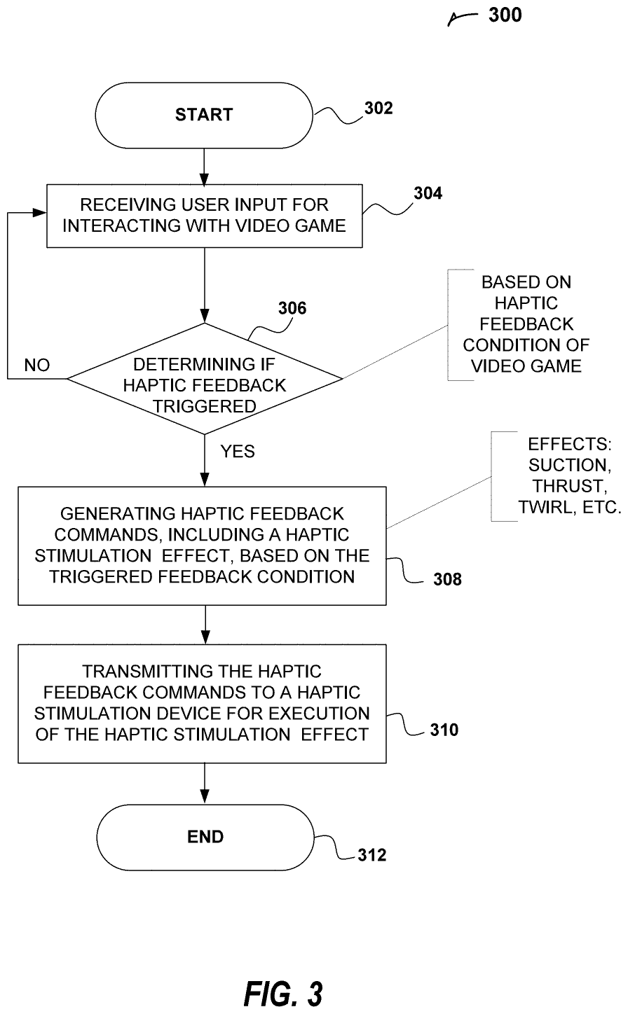

FIG. 3 is a flow diagram of a method 300 for control of a haptic stimulation device (e.g., 118 of FIG. 1) by a video game (e.g., 122 of FIG. 1), according to embodiments of the present disclosure. In some embodiments, the operations of FIG. 3 may be implemented in program code that is executed by at least one processor, for example, the processor in a general purpose computer, a mobile device, or a gaming console (e.g., computing device 114 of FIG. 1). To help understand how each of the operations of method 300 might be performed, the following description is provided in the context of the element numbers of the example system 100 as shown in FIG. 1. However, it is understood that embodiments according to the present disclosure may be implemented with any combination of alternative elements.

At operation 302, the computing device 114 may begin operations for control of haptic stimulation device 118 by video game application 122.

At operation 304, the computing device 114 may receive input signals from user input device 116 for interacting with video game application 122 running on the computing device 114. For example, a player of video game application 122 may control the movement of a video game element 126 (e.g., a puzzle piece) on display device 110 via user input device 116 in the form of a video game controller.

At operation 306, the video game 122 running on computing device 114 may determine whether the input signals received from user input device 116 trigger any haptic feedback conditions of video game application 122 for the generation of any haptic feedback commands 124. For example, a player of video game 122 may control the movement of video game element 126 on display 110 such that a haptic feedback condition is triggered (e.g., a failure or a victory as described above with respect to FIG. 1 and FIG. 2) in video game application 122. In another example, the player of video game 122 may control the movement puzzle piece 126 on display 110 such that a position of puzzle piece 126 on display 110 triggers a haptic feedback condition for the generation of haptic feedback commands 124 (e.g., placed puzzle piece 126 is placed closer to the top of display 110 than the other puzzle pieces). In yet another example, the player of video game 122 may control the movement puzzle piece 126 on display 110 such that a speed and/or acceleration of the puzzle piece 126 on display 110 triggers a haptic feedback condition for the generation of haptic feedback commands 124 (e.g., the player has progressed in the video game 122 and the speed of the puzzle piece 126 increases).

Based on no input signals being received, from user input device 116, that trigger a haptic feedback condition for the generation of haptic feedback commands 124, the method may return to operation 304 to await further input signal from the user input device 116 for interacting with the video game application 122. Based on input signals being received, from user input device 116, that do trigger a haptic feedback condition for the generation of haptic feedback commands 124, the method may proceed to operation 308 as described below.

At operation 308, the computing device 114 may generate haptic feedback commands 124 based on the triggering of at least one haptic feedback condition of video game application 122. The haptic feedback commands 124 may indicate a haptic stimulation effect (e.g., vibrate, suction, thrust, twirl, etc.) to be executed by haptic stimulation device 118. For example, the haptic stimulation effect may be determined based on the capabilities of the haptic stimulation device 118. If the haptic stimulation device 118 is capable of performing multiple haptic stimulation effects the video game 122 may select from these based on, for example, the event, position, speed, etc. that was the basis for the haptic feedback commands 124, as explained above. Alternatively, the selection of the stimulation effect performed by haptic stimulation device may be overridden via a user configuration, for example, via a setup menu page of video game 122 on display device 110.

At operation 310, the computing device 114 may transmit the haptic feedback commands 124 to the haptic stimulation device 118, for execution of the haptic stimulation effect, in the form of command signals transmitted via communication network 120 or via a wired connection to computing device 114, as described above.

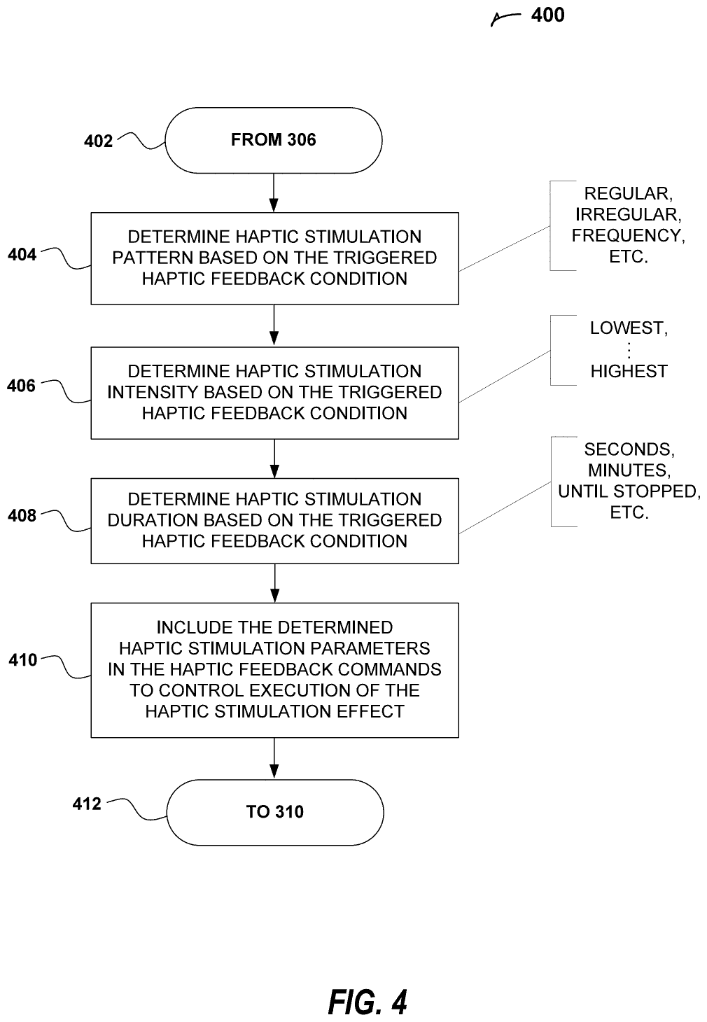

FIG. 4 is a flow diagram of a method 400 for control of a haptic stimulation device (e.g., 118 of FIG. 1) by a video game (e.g., 122 of FIG. 1), according to embodiments of the present disclosure.

At operation 402, method 400 may continue from operation 306 of method 300 of FIG. 3 as described above.

At operation 404, based on a haptic feedback condition of video game application 122 having been triggered, a pattern for the haptic stimulation effect (e.g., vibrate, suction, thrust, twirl, etc.) to be executed by haptic stimulation device 118 may be determined. For example, the pattern of the haptic stimulation effect may be a regular rhythmic pattern or an irregular pattern that is hard to predict for the user. Furthermore, a frequency or speed of the vibrations, thrusts, twirls, etc. of the pattern may also be determined for the pattern. As noted above with respect to method 300 of FIG. 3, the determination may be based on: the capabilities of the haptic stimulation device 118, the triggered haptic feedback condition, or any overrides provided via a user configuration.

At operation 406, based on a haptic feedback condition of video game application 122 having been triggered, an intensity for the haptic stimulation effect (e.g., vibrate, suction, thrust, twirl, etc.) to be executed by haptic stimulation device 118 may be determined. For example, the intensity of the haptic stimulation effect may be selected from a discrete group of settings (e.g., low, medium or high) or from a more granular numerical scale may be used (e.g., 1, 2, 3 . . . 10). As noted above with respect to method 300 of FIG. 3, the determination may be based on: the capabilities of the haptic stimulation device 118, the triggered haptic feedback condition, or any overrides provided via a configuration.

At operation 408, based on a haptic feedback condition of video game application 122 having been triggered, a duration for the haptic stimulation effect (e.g., vibrate, suction, thrust, twirl, etc.) to be executed by haptic stimulation device 118 may be determined. For example, the duration of the haptic stimulation effect may be selected based on a specified time period (e.g., 3 seconds or 1 minute). Furthermore, a duration of the haptic stimulation effect may be based on the reception of further haptic feedback commands 124 so that haptic stimulation device 118 performs the haptic stimulation effect until the player achieves some further goal (e.g., another “condition” in video game 122). As noted above with respect to method 300 of FIG. 3, the determination may be based on: the capabilities of the haptic stimulation device 118, the triggered haptic feedback condition, or any overrides provided via a user configuration.

At operation 410, if haptic feedback parameters (e.g., pattern, intensity and/or duration) have been generated they may be included in the haptic feedback commands 124 to control the execution of the stimulation effect (e.g., vibrate, suction, thrust, twirl, etc.) by the haptic feedback device 118.

At operation 412, method 400 may continue to operation 310 of method 300 of FIG. 3 as described above.

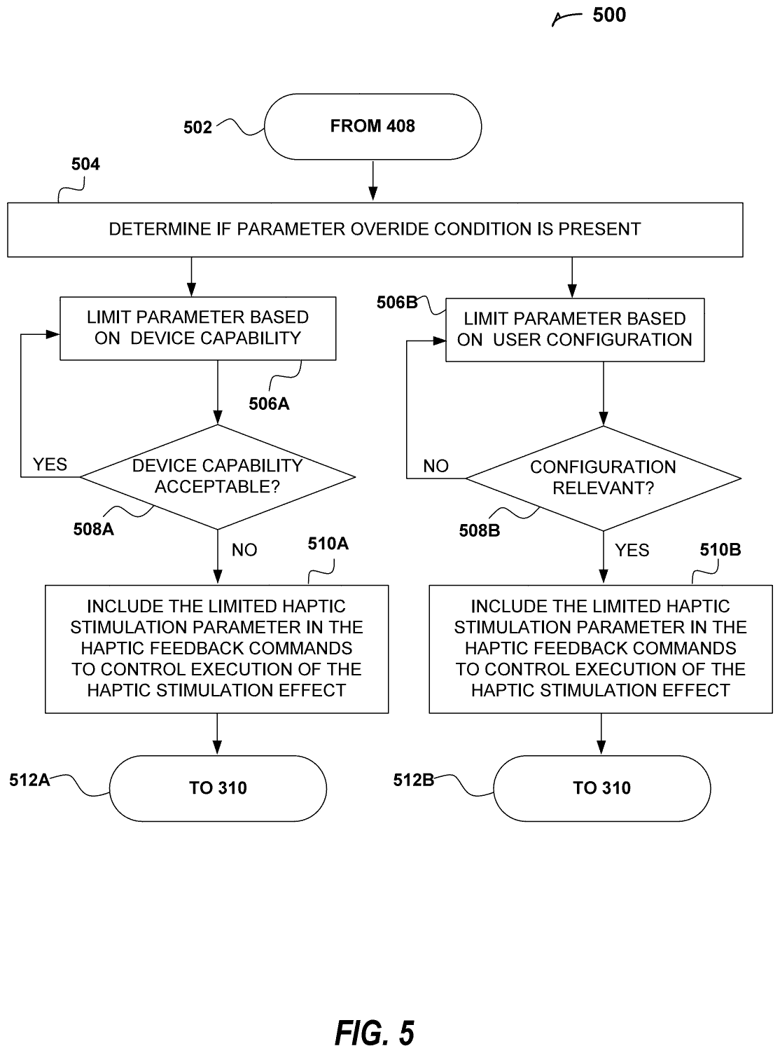

FIG. 5 is a flow diagram of a method 500 for control of a haptic stimulation device (e.g., 118 of FIG. 1) by a video game (e.g., 122 of FIG. 1), according to embodiments of the present disclosure.

At operation 502, method 500 may continue from operation 408 of method 400 of FIG. 4 as described above.

At operation 504, based on determinations having been made with regard to a haptic stimulation effect and haptic stimulation parameters (e.g., pattern, intensity and/or duration) to be performed by haptic stimulation device 118, the computing device 114 may determine whether any overrides conditions are present with respect to the execution of the stimulation effect according to the haptic stimulation parameters.

At operation 506A, the computing device 114 may limit at least one determined haptic stimulation parameter based on a capability of the haptic stimulation device 118 with respect to the at least one haptic stimulation parameter. For example, the haptic stimulation device 118 may have a lower suctioning capability than the intensity specified for a suction stimulation effect by the determined haptic stimulation parameters based on the triggered condition in video game application 122.

At operation 506B, the computing device 114 may limit at least one determined haptic stimulation parameter based on a configuration by a user of system 100 with respect to the at least one haptic stimulation parameter (e.g., a user never wants to go beyond a configured intensity or frequency threshold).

At operation 508A, the computing device 114 may determine whether a capability of the haptic stimulation device 118 with respect to the at least one determined haptic stimulation parameter is acceptable, e.g., is the capability sufficient to execute the haptic stimulation effect in accordance with the at least one determined haptic stimulation parameter. Based on the capability of the haptic stimulation device 118 with respect to the at least one determined haptic stimulation parameter being acceptable, method 500 may return to operation 506A. Based on the capability of the haptic stimulation device 118 with respect to the at least one determined haptic stimulation parameter not being acceptable, method 500 may proceed to operation 510A.

At operation 508B, the computing device 114 may determine whether a configuration by the user of system 100 is relevant to the at least one determined haptic stimulation parameter, e.g., is the configuration in conflict with the execution of the haptic stimulation effect in accordance with the at least one determined haptic stimulation parameter. Based on the user configuration not being relevant to the execution of the haptic stimulation effect in accordance with the at least one determined haptic stimulation parameter, method 500 may return to operation 506B. Based on the user configuration being relevant to the execution of the haptic stimulation effect in accordance with the at least one determined haptic stimulation parameter, method 500 may proceed to operation 510A.

At operation 510A, based on the capability of haptic stimulation device 118 not being acceptable, the at least one determined haptic stimulation parameter may be limited by the capability of the haptic stimulation device 118 before it is included in haptic feedback commands 124. The computing device may then transmit the haptic feedback commands 124 to the haptic stimulation device 118 in the form of command signals communicated via communication network 120 or via a wired connection to computing device 114, as noted above.

At operation 510B, based on the user configuration being relevant, the at least one determined haptic stimulation parameter may be limited by the user configuration before it is included in haptic feedback commands 124. The computing device may then transmit the haptic feedback commands 124 to the haptic stimulation device 118 in the form of command signals communicated via communication network 120 or via a wired connection to device 114.

At operations 512A and 512B, method 500 may continue to operation 310 of method 300 of FIG. 3 as described above.

### Computing Device

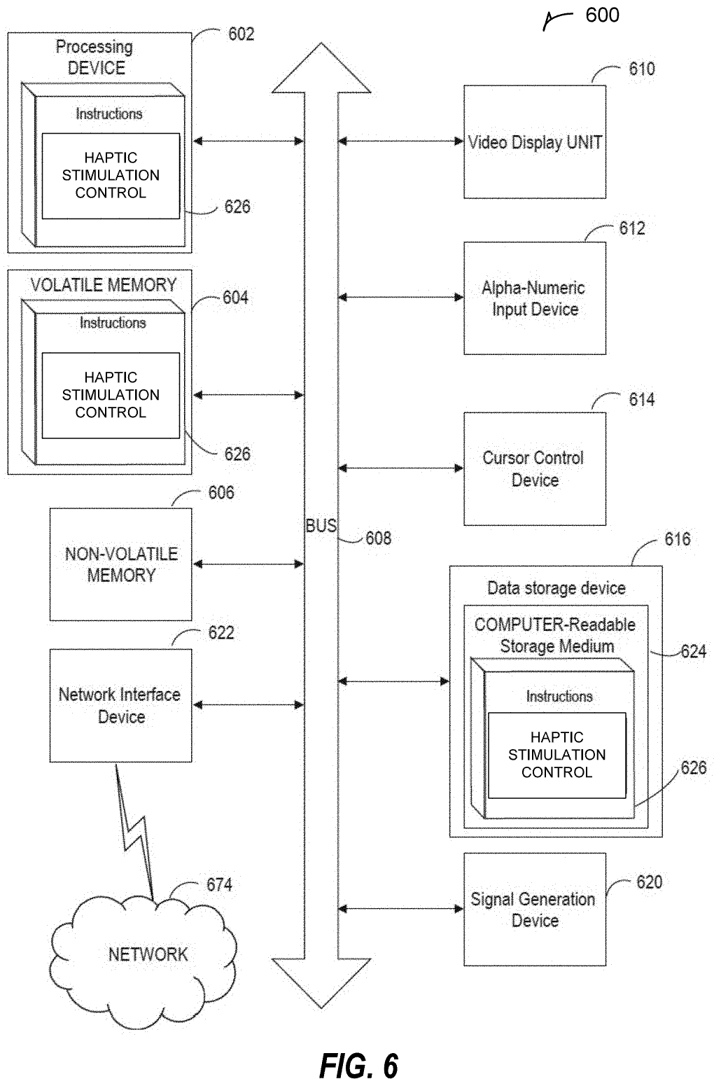

FIG. 6 depicts a block diagram of a computer system 600 operating in accordance with one or more aspects of the present disclosure. In various illustrative examples, computer system 600 may correspond to the computing device 114 of FIG. 1.

In certain implementations, computer system 600 may be connected (e.g., via a network, such as a Local Area Network (LAN), an intranet, an extranet, or the Internet) to other computer systems. Computer system 600 may operate in the capacity of a server or a client computer in a client-server environment, or as a peer computer in a peer-to-peer or distributed network environment. Computer system 600 may be provided by a personal computer (PC), a tablet PC, a set-top box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 600 may include a processing device 602, a volatile memory 604 (e.g., random access memory (RAM)), a non-volatile memory 606 (e.g., read-only memory (ROM) or electrically-erasable programmable ROM (EEPROM)), and a data storage device 616, which may communicate with each other via a bus 608.

Processing device 602 may be provided by one or more processors such as a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, an application specific integrated circuit (ASIC), a field programmable gate array (FPGA), a digital signal processor (DSP), or a network processor).

Computer system 600 may further include a network interface device 622. Computer system 600 also may include a video display unit 610 (e.g., an LCD), an alphanumeric input device 612 (e.g., a keyboard), a cursor control device 614 (e.g., a mouse), and a signal generation device 620.

Data storage device 616 may include a non-transitory computer-readable storage medium 624 on which may store instructions 626 encoding any one or more of the methods or functions described herein, including instructions for haptic stimulation control by video game application 122 of FIG. 1 by implementing method 300 of FIG. 3.

Instructions 626 may also reside, completely or partially, within volatile memory 604 and/or within processing device 602 during execution thereof by computer system 600, hence, volatile memory 604 and processing device 602 may also constitute machine-readable storage media.

While computer-readable storage medium 624 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and computer program components or in computer programs.

### Languge

Unless specifically stated otherwise, terms such as “receiving,” “associating,” “determining,” “updating” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and may not have an ordinal meaning according to their numerical designation.

Examples described herein also relate to an apparatus for performing the methods described herein. This apparatus may be specially constructed for performing the methods described herein, or it may comprise a general purpose computer system selectively programmed by a computer program stored in the computer system. Such a computer program may be stored in a computer-readable tangible storage medium.

The methods and illustrative examples described herein are not inherently related to any particular computer or other apparatus. Various general purpose systems may be used in accordance with the teachings described herein, or it may prove convenient to construct more specialized apparatus to perform methods 300, 400 and 500 and/or each of their individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

1. A computer implemented method for video game control of a haptic stimulation device, comprising:
receiving, by a computing device, user input for interacting with a video game application running on the computing device;
determining, by the computing device, that the interacting has triggered a haptic feedback condition of the video game application;
generating, by the computing device, haptic feedback commands including a haptic stimulation effect, based on the feedback condition; and
transmitting, by the computing device, the haptic feedback commands to the haptic stimulation device for execution of the stimulation effect.

2. The method of claim 1, wherein the haptic feedback condition includes at least one of a position, a number, a speed, or an acceleration of at least one graphical element of the video game application shown on a display device.

3. The method of claim 1, wherein the haptic feedback condition includes at least one of a success or failure determined by the video game application.

4. The method of claim 1, wherein the haptic stimulation effect comprises a suction effect.

5. The method of claim 1, wherein the haptic stimulation effect comprises a thrust effect.

6. The method of claim 1, wherein the haptic stimulation effect comprises a twirl effect.

7. The method of claim 1, further comprising:
generating, by the computing device, haptic stimulation parameters based on the triggered haptic feedback condition; wherein:
the haptic feedback commands include the haptic stimulation parameters; and
the execution of the haptic stimulation effect is based on the haptic stimulation parameters.

8. The method of claim 7, wherein the haptic stimulation parameters include at least one of a haptic stimulation pattern, a haptic stimulation intensity or a haptic stimulation duration associated with the haptic stimulation effect.

9. The method of claim 8, wherein the haptic stimulation pattern includes at least one of a number, a frequency, a regularity or an irregularity associated with the execution of the haptic stimulation effect.

10. The method of claim 8, wherein the haptic stimulation intensity includes at least one of a level setting or a number setting to control a force associated with the haptic stimulation effect.

11. The method of claim 8, wherein the haptic stimulation duration includes at least one of a number of seconds or a number of minutes to control a time period associated with the haptic stimulation effect.

12. The method of claim 1, further comprising:
determining, by the computing device, that the haptic stimulation parameters should be limited based on an override condition, wherein:
the override condition is based on at least one of a capability of the haptic stimulation device or a user configuration of the video game application.

13. A system for video game control of a haptic stimulation device, comprising:
a computing device, communicatively coupled to the haptic stimulation device, to:
receive user input for interacting with a video game application running on the computing device;
determe that the interacting has triggered a haptic feedback condition of the video game application;
generate haptic feedback commands including a haptic stimulation effect, based on the haptic feedback condition; and
transmit the haptic feedback commands to the haptic stimulation device for execution of the haptic stimulation effect.

14. The system of claim 13, wherein the haptic feedback condition includes at least one of a position, a number, a speed, or an acceleration of at least one graphical element of the video game application shown on a display device.

15. The system of claim 13, wherein the haptic feedback condition includes at least one of a success or failure determined by the video game application.

16. The system of claim 13, wherein the haptic stimulation effect includes at least one of a suction, a thrust or a twirl.

17. The system of claim 13, the computing device further to:
generate haptic stimulation parameters based on the triggered haptic feedback condition; wherein:
the haptic feedback commands include the haptic stimulation parameters; and
the execution of the haptic stimulation effect is based on the haptic stimulation parameters.

18. The system of claim 17, wherein the haptic stimulation parameters include at least one of a haptic stimulation pattern, a haptic stimulation intensity or a haptic stimulation duration associated with the haptic stimulation effect.

19. The system of claim 18, wherein:
the haptic stimulation pattern includes at least one of a number, a frequency, a regularity or an irregularity associated with the execution of the haptic stimulation effect;
the haptic stimulation intensity includes at least one of a level setting or a number setting to control a force associated with the haptic stimulation effect; and
the haptic stimulation duration includes at least one of a number of seconds or a number of minutes to control a time period associated with the haptic stimulation effect.

20. A computer readable medium (CRM) storing instructions which, when executed, cause one or more processors to perform operations for video game control of a haptic stimulation device, the operations comprising:
receiving user input for interacting with a video game application running on the computing device;
determining that the interacting has triggered a haptic feedback condition of the video game application;
generating haptic feedback commands including a haptic stimulation effect, based on the haptic feedback condition; and
transmitting the haptic feedback commands the haptic stimulation device for execution of the haptic stimulation effect.
